(19) United States
(12) Patent Application Publication
(10) Pub. No.: US 2025/0108370 A1
(43) Pub. Date: Apr. 3, 2025

(54) Modular Microfluidic Analyte Screening with Multiple Parallel Assays and Multiple Shear Rates

(71) Applicant: U.S. Army DEVCOM, Army Research Laboratory, Adelphi, MD (US)

(72) Inventors: Jose A. Wippold, Washington, DC (US); Mark T. Kozlowski, Perry Hall, MD (US); Joshua A. Orlicki, Havre de Grace, MD (US); Justin P. Jahnke, Bethesda, MD (US)

(21) Appl. No.: 18/376,189

(22) Filed: Oct. 3, 2023

(51) Int. Cl. B01L 3/00

(52) U.S. Cl. CPC B01L 3/502707; B01L 2200/0647; B01L 2200/12; B01L 2300/0864; B01L 2300/12

(57) ABSTRACT

A microfluidic test chip that may provide multiple parallel assays on a modular base that is able to be used for fluorescent imaging and analysis is described. The microfluidic test chip may provide multiple parallel evaluation branches. Each parallel evaluation channel may have the same volume as each other parallel evaluation channel. Each parallel evaluation channel may include multiple sub-branches. Each sub-channel may have the same volume as each other sub-channel. In this way, consistent flow rates may be provided across each parallel evaluation channel and sub-channel. Each parallel evaluation sub-channel may include multiple evaluation zones. Each evaluation zone may be associated with different evaluation attributes, such as flow rate, reactant type, etc.

### GOVERNMENT INTEREST

The invention described herein may be manufactured, used and licensed by or for the U.S. Government.

### FIELD OF THE INVENTION

The invention is related to microfluidic analysis.

### BACKGROUND OF THE INVENTION

Existing solutions require multiple test chips to evaluate different test conditions and/or reactants.

Thus, there is a need for a test chip that can implement multiple parallel tests with varying conditions.

### BRIEF SUMMARY OF THE INVENTION

In some embodiments, a microfluidic test chip may provide multiple parallel assays on a modular base and can be paired with assay analysis interrogation techniques, such as fluorescent imaging, optical microscopy, impedance analysis, and/or other appropriate techniques.

The microfluidic test chip may provide a fluid channel with multiple parallel evaluation branches. Each parallel evaluation branch may have the same volume as each other parallel evaluation branch. In this way, consistent flow rates may be provided across each parallel evaluation branch. In some embodiments, the fluid channel may include a single evaluation branch.

Each parallel evaluation branch may include multiple parallel evaluation sub-branches. Each parallel evaluation sub-branch may have the same volume as each other parallel evaluation sub-branch. In this way, consistent flow rates may be provided across each parallel evaluation sub-branch. In some embodiments, each parallel evaluation branch may not include any sub-branches.

Each parallel evaluation sub-branch (or each parallel evaluation branch if there are no parallel evaluation sub-branches) may include multiple evaluation zones in series. Each evaluation zone may be associated with different evaluation attributes, such as flow rate, reactant type, etc. The various evaluation zones may be associated with a single substrate.

A channel layer may be coupled to the substrate and a cover coupled to the channel to form a hermetically sealed device. The channel layer may have a cavity that includes the parallel evaluation branches and parallel evaluation sub-branches. The term “channel” or “fluid channel” may refer to a cavity that includes the parallel evaluation branches, parallel evaluation sub-branches, evaluation zones, conduit sections, inlets, outlets, and/or other appropriate elements that may be associated with fluid transport.

### BRIEF DESCRIPTION OF THE DRAWINGS

The novel features of the disclosure are set forth in the appended claims. However, for purpose of explanation, several embodiments are illustrated in the following drawings.

FIG. 1 illustrates an example of a top-down overview of one or more embodiments described herein, in which a microfluidic test chip provides multiple parallel evaluation branches;

FIG. 2 illustrates a side-on view of a microfluidic test chip of one or more embodiments described herein;

FIG. 3 illustrates a top-down view of a substrate of one or more embodiments described herein;

FIG. 4 illustrates a top-down view of a channel of one or more embodiments described herein;

FIG. 5 illustrates a top-down view of a cover of one or more embodiments described herein;

FIG. 6 illustrates a top-down view of a fluid interfacing adhesive of one or more embodiments described herein;

FIG. 7 illustrates a top-down view of a microfluidic test chip of one or more embodiments described herein;

FIG. 8 illustrates a top-down view of a microfluidic test chip of one or more embodiments described herein;

FIG. 9 illustrates a flow chart of an exemplary process that manufactures a test chip of some embodiments;

FIG. 10 illustrates a flow chart of an exemplary process that designs a test chip of some embodiments;

FIG. 11 illustrates a flow chart of an exemplary process that implements a test via the test chip of some embodiments; and

FIG. 12 illustrates a schematic block diagram of one or more exemplary devices used to implement various embodiments.

### DETAILED DESCRIPTION OF THE INVENTION

The following detailed description describes currently contemplated modes of carrying out exemplary embodiments. The description is not to be taken in a limiting sense, but is made merely for the purpose of illustrating the general principles of some embodiments, as the scope of the disclosure is best defined by the appended claims.

Various features are described below that can each be used independently of one another or in combination with other features. Broadly, some embodiments generally provide a microfluidic test chip including multiple parallel evaluation branches.

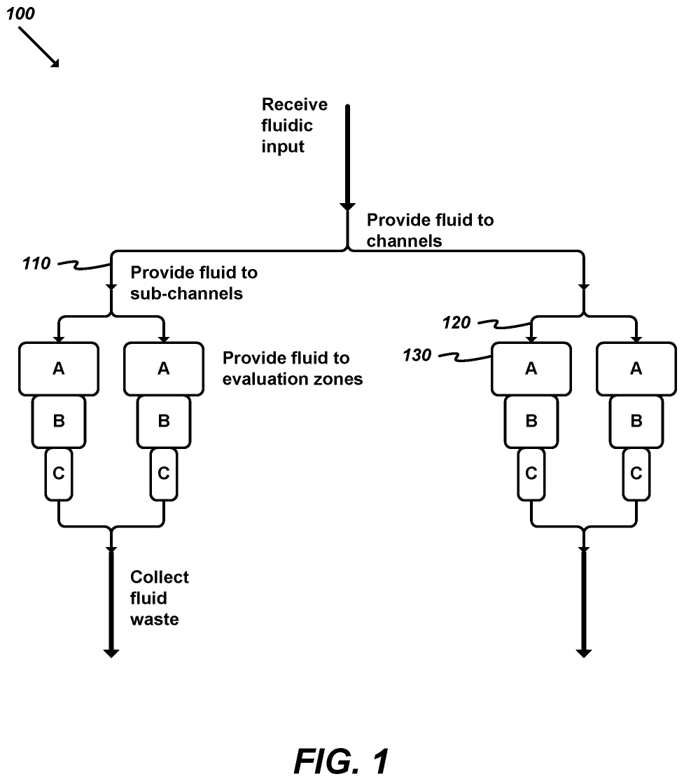

FIG. 1 illustrates an example overview of one or more embodiments described herein, in which a microfluidic test chip 100 provides multiple parallel evaluation branches. Each fluid branch 110 may include multiple fluid sub-branches 120. Each fluid sub-branch 120 may include multiple evaluation zones 130. The modular capability of the microfluidic test chip 100 may allow for various types of evaluation zones 130 with various associated flow rates.

Each fluid branch 110 may include multiple fluid sub-branches 120. In this example, each fluid branch 110 has the same volume as each other fluid branch 110. Similarly, each fluid sub-branch 120 may have the same volume as each other fluid sub-branch 120. Thus, flow rates may be the same through each fluid branch 110 and each fluid sub-branch 120.

Each evaluation zone 130 may be associated with a different reactant (e.g., a substance or compound, antibody, material, biological particle, analyte, species, etc.). In some cases, each evaluation zone 130 may be associated with sections of a substrate, where each substrate section may be a nominally planar surface of defined composition, texture, and roughness. Each substrate section may be, include, or utilize a conformal material having substantial curvature or topography.

In this example, each fluid sub-branch 120 includes a set of evaluation zones 130 (“A”, “B”, and “C”) such that multiple tests may be performed in parallel. Different embodiments of the microfluidic test chip 100 may include various different arrangements of evaluation zones 130. For example, some embodiments may include the same reactant across evaluation zones 130 with different flow rates.

The volume of each evaluation zone 130 (or cross-section, for evaluation zones of varying length) may be proportional to a width of the evaluation zone 130 in this view. Shear rate may be increased as fluid travels along each fluid sub-branch 120 (e.g., the width of the evaluation zones 130 may decrease as fluid moves along each fluid sub-branch 120).

Fluid may be received from a pump or syringe at an inlet port of the microfluidic test chip 100. The fluid may be distributed across the fluid branches 110 and fluid sub-branches 120, before being collected via one or more outlet ports of the microfluidic test chip 100.

The evaluation zones 130 may include features such as photoluminescent or fluorescent particles that may provide visual indications of the adhesion associated with each evaluation zone 130 (e.g., changes in luminance, color, graphics or indicators, etc.).

Microfluidic test chip 100 may be used for various types of testing across various types of substances. For example, microfluidic test chip 100 may be used to test peptides of interest for adhesive properties against polymers of interest, such as adhesion of Escherichia coli (E. coli) cells displaying a surface peptide to polycarbonate or poly (methyl methacrylate) (PMMA, or “acrylic” or “acrylic glass”). As another example, microfluidic test chip 100 may include evaluation zones 130 coated with antibodies or antigens of interest and pharmaceutical compounds may be tested across a range of conditions (e.g., the evaluation zones 130 that indicate adhesion with the highest flow rates may be most likely to adhere and stay adhered in different usage scenarios).

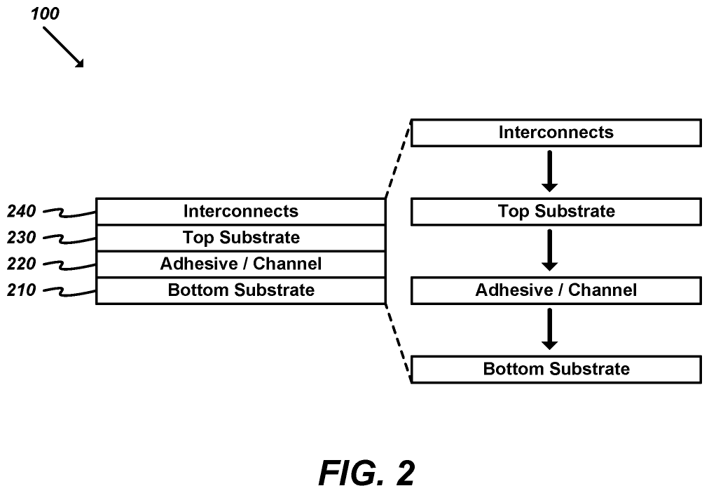

FIG. 2 illustrates a side-on view of a microfluidic test chip 100 of one or more embodiments described herein. As shown, the microfluidic test chip 100 may include multiple layers 210-240 that form a hermetically sealed device. In this example, the microfluidic test chip 100 includes a bottom substrate 210, adhesive/channel 220, top substrate 230, and interconnects 240. One of ordinary skill in the art will recognize that microfluidic test chip 100 may include various other components, such as fluid couplings, connectors, etc. The layers 210-240 may have varying thicknesses, with the thickness in this example exaggerated for clarity.

The layers 210-240 may include materials such as polycarbonate, poly (acrylate), poly (methacrylate), an olefin including polypropylene (PP), polyethylene (PE), cyclic olefin & related copolymers, polyethylene terephthalate (PET), polyamides and aramids, polyimides, polystyrene (PS) and related substituted forms, polytetrafluoroethylene and related polyvinyl per-fluorinated or semi-fluorinated compositions, silicones, polyurethanes, polyacrylonitrile (PAN), natural and synthetic rubbers, carbon-carbon materials, and elastomers. In some embodiments, the layers 210-240 may include an inorganic material such as a glassy or crystalline material (e.g., borosilicate, ion-substituted glass, ceramics including SiC, B₄C, ruby, germanium, metal alloys (including steel), metal oxides (including aluminum) and ceramic metal oxide materials).

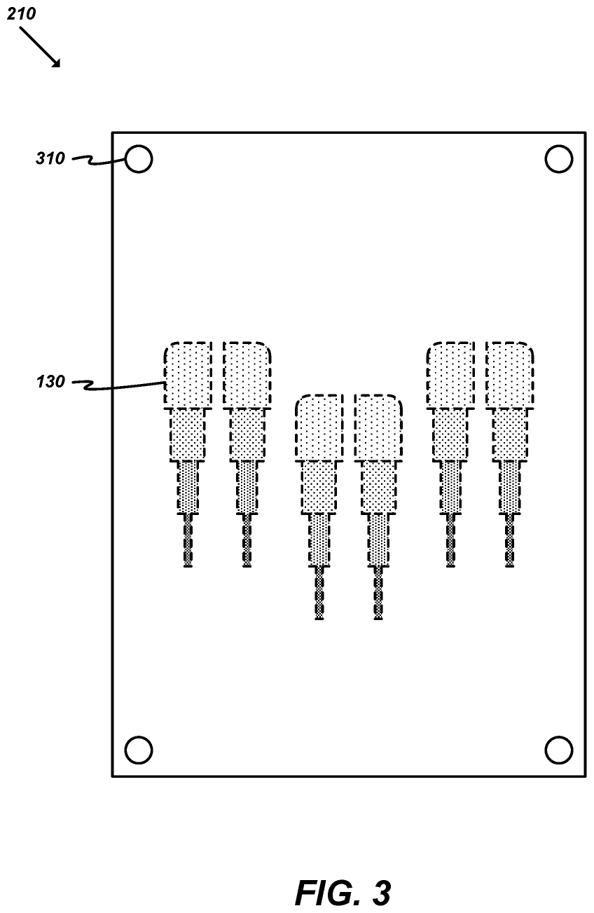

FIG. 3 illustrates a top-down view of a bottom substrate 210 of one or more embodiments described herein. Bottom substrate 210 may include materials such as polycarbonate, PMMA, glass, other plastics and/or polymers, metals, etc. In this example, the different evaluation zones 130 are indicated by different fill patterns. In this example, each fluid sub-branch 120 includes the same set of evaluation zones 130 in the same order, such that the flow rates for each evaluation zone 130 in each fluid sub-branch 120 is the same as the corresponding evaluation zone 130 in a parallel fluid sub-branch 120.

Different embodiments may arrange the evaluation zones 130 in various ways depending on various relevant factors (e.g., different types of evaluation zones 130 may be arranged in different orders, in parallel, in serial, etc.). For example, materials may be tested for adherence to a material or compound (e.g., paints may be tested with respect to adherence to a material used to build ship hulls) by arranging multiple evaluation zones 130 of the same type in series, such that different flow rates are applied at the different evaluation zones 130.

Each alignment feature 310 may be, include, or utilize a graphical element or indicator, a physical feature such as a through hole, and/or other appropriate elements. In this example, there are four alignment features 310. Different embodiments may include various numbers and/or arrangements of alignment features 310. In some embodiments, the alignment features 310 may be used during etching or other processing to the layers 210-240 of the microfluidic test chip 100. Such alignment features 310 may be used by optical elements (e.g., cameras) to align the elements of each layer 210-240 with each other, and/or may engage various features of a fixture or similar element (e.g., a set of four posts). In some embodiments, the alignment features 310 may be used during assembly of the layers 210-240 (e.g., a fixture may include posts that engage the alignment features 310 of multiple layers 210-240).

Each evaluation zone 130 may include various materials, compounds, substances, etc. as may be desired to be evaluated. The evaluation zones 130 may be associated with the bottom substrate 210 in various appropriate ways. For instance, adhesives may be used to couple evaluation zones 130 to the bottom substrate 210. As another example, substances may be deposited onto the bottom substrate 210 at the evaluation zone 130 locations. As another example, sections of the bottom substrate 210 may be impregnated with various substances or compounds to form the evaluation zones 130.

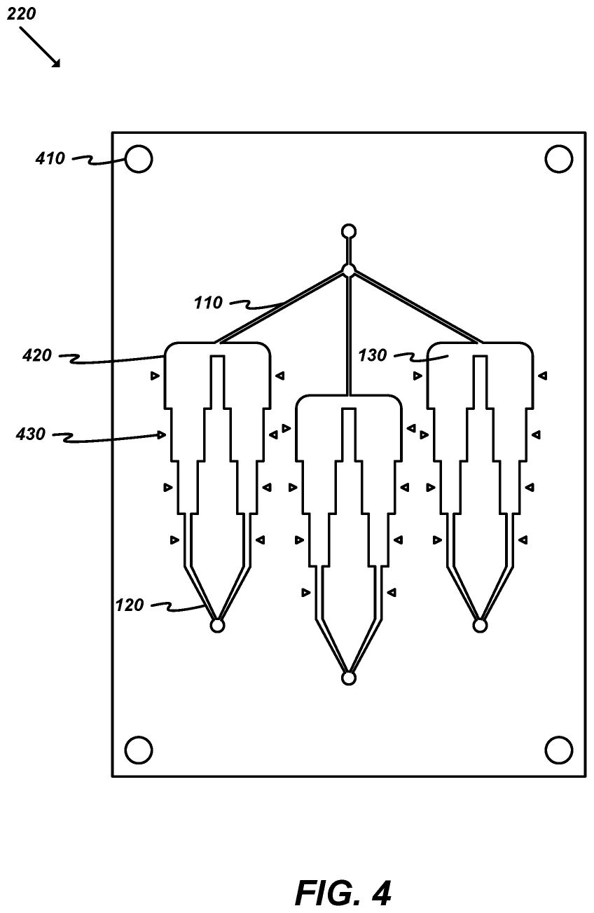

FIG. 4 illustrates a top-down view of an adhesive/channel 220 or adhesive/channel layer of one or more embodiments described herein. Each alignment feature 410 may be similar to alignment feature 310 described above. In this example, the adhesive/channel 220 may be a double-sided adhesive that may be coupled to the bottom substrate 210 and the top substrate 230. A channel cavity 420 may be cut or etched and sections of adhesive/channel 220 associated with the channel cavity 420 may be removed (e.g., by cutting or etching those portions of the adhesive/channel 220). Adhesive/channel 220 may include materials that are appropriate for use with a laser cutter (e.g., materials that may be laser cut without igniting). Adhesive/channel 220 may include a core or carrier that may include materials such as polycarbonate, PMMA, glass, other plastics and/or polymers, metals, etc.

Channel cavity 420 may include the various fluid branches 110 and fluid sub-branches 120 across multiple parallel paths, as shown. In this example, fluid flows from top to bottom, and the shear force increases as fluid travels along each fluid sub-branch 120. Each evaluation zone 130 may have the same height (e.g., the height of channel cavity 420), shear force will scale inversely proportionally to the resulting cross-section of the section of sub-branch 120, where the width may change at the border of each evaluation zone 130 as shown. In this example, each fluid sub-branch 120 has the same volume as each other fluid sub-branch 120 (including the evaluation zones 130 and conduit sections).

Each reference feature 430 may be a visual indicator that may serve as a reference when capturing image data, evaluating results, etc. In this example, the reference features 430 are triangles that may be etched into the adhesive/channel 220. Different embodiments may include various reference features 430.

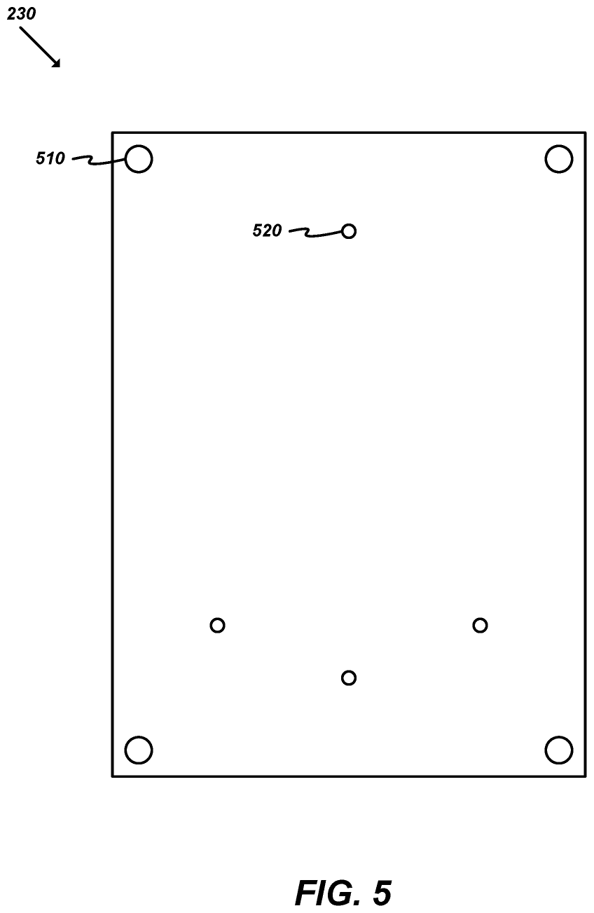

FIG. 5 illustrates a top-down view of a top substrate 230 of one or more embodiments described herein. Each alignment feature 510 may be similar to alignment feature 310 described above. Top substrate 230 may include materials such as polycarbonate, PMMA, glass, other plastics and/or polymers, metals, etc. Top substrate 230 may be transparent or semi-transparent such that microfluidic test chip 100 may be evaluated using cameras, microscopes, and/or other appropriate equipment.

Each fluid port 520 may include a through-hole or other cavity that may allow fluid to flow into, or out of, the microfluidic test chip 100. Each fluid port 520 may be coupled to a connector or similar element that may allow the microfluidic test chip 100 to transfer fluid with other components, devices, or systems (e.g., a pump, a waste collection resource, etc.).

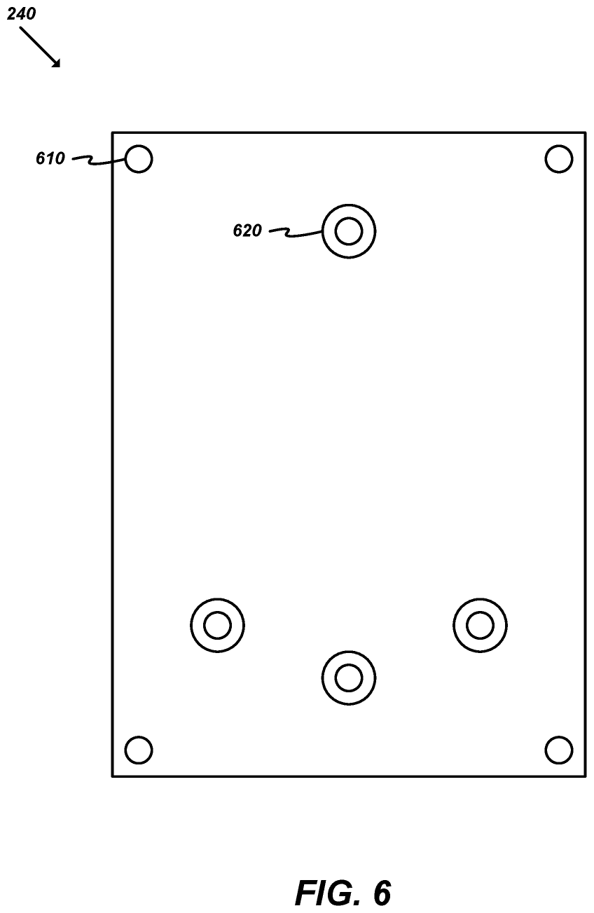

FIG. 6 illustrates a top-down view of an interconnects 240 or interconnect layer of one or more embodiments described herein. Each alignment feature 610 may be similar to alignment feature 310 described above.

Each fluid port 620 may include a through-hole or other cavity that may allow fluid to flow between layers (e.g., between top substrate 230 and adhesive/channel 220). Each fluid port 620 may include a seal or gasket (e.g., a rubber or silicone seal or gasket) in some embodiments.

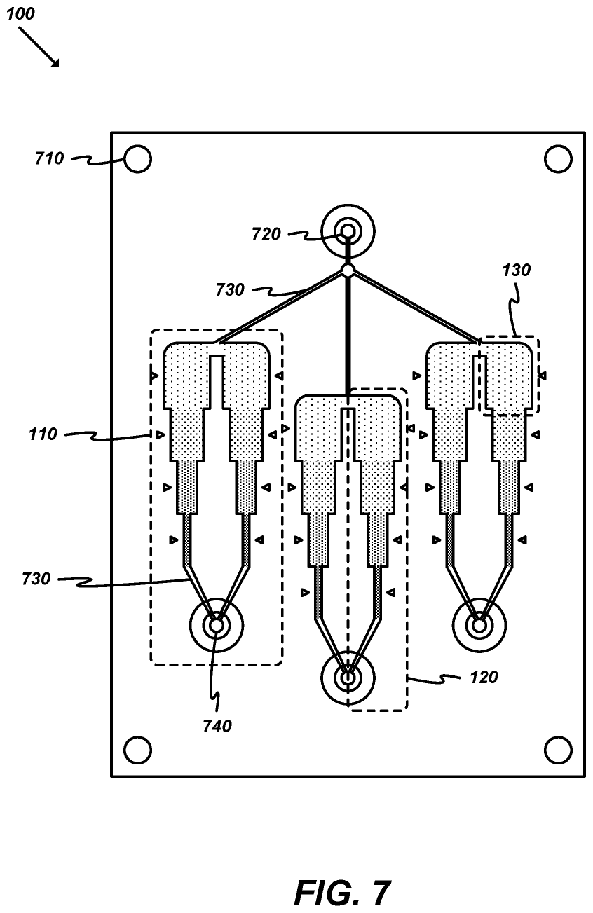

FIG. 7 illustrates a top-down view of a microfluidic test chip 100 of one or more embodiments described herein. Microfluidic test chip 100 may include layers 210-240. In this example, the layers are transparent, such that features on lower layers are visible in this view.

Each alignment feature 710 may include alignment features 310-710. Alignment feature 710 may include a through-hole that includes a through-hole alignment feature 310-710 from each layer 210-240. Alignment feature 710 may be used to assemble the layers 210-240 to form microfluidic test chip 100. For instance, a fixture may include a post associated with each alignment feature 710 that may allow the various layers to be precisely aligned when being coupled together (e.g., via adhesive 220 or fluid interfacing adhesive 240).

Fluid inlet 720 may be associated (and/or aligned) with a fluid port 520 of the top substrate 230, a fluid port 620 of the fluid interfacing adhesive 240, and a portion of channel cavity 420 that is aligned with the fluid ports 620 and 520 as shown. Fluid inlet 720 may be associated with various couplings and/or connectors that may allow resources such as pumps, syringes, etc. to be coupled to the fluid inlet 720 and provide fluid to the microfluidic test chip 100. Such a pump or syringe may be controllable such that the flow rate, volume, and/or other attributes of the provided fluid may be controlled and/or monitored.

Fluid conduit 730 may include inlet sections, outlet sections, coupling sections (e.g., the circular section connecting the three fluid branches 110), traversing sections (e.g., the rectangular or triangular sections of the fluid branches 110). Sections of conduit 720 may be included in the fluid branches 110 or fluid sub-branches 120 and may be included when calculating the volume of such fluid branches 110 or fluid sub-branches 120 to ensure matching operating parameters across the fluid branches 110 or fluid sub-branches 120. Fluid conduit 730 may be sized and/or shaped based on various relevant parameters, such as the volume of channel cavity 420 (or other sections thereof), input flow rate, attributes of the evaluation zones 130 (e.g., size, composition, etc.), etc.

Each fluid branch 110 may include portions of conduit 730, one or more outlets 740, and multiple fluid sub-branches 120. Each fluid sub-branch 120 may include portions of conduit 730, an inlet, an outlet, and multiple evaluation zones 130. As shown, width of the sub-branch 120 may decrease along the fluid path from the fluid inlet 720 to the fluid outlets 740.

In this example, each fluid sub-branch 120 has the same volume as each other fluid sub-branch 120, but different embodiments may include differently size fluid sub-branches 120, as appropriate for desired flow rate, volume, and/or other relevant parameters or attributes.

Each evaluation zone 130 may include various materials, elements, substances, components, and/or other items that may be evaluated through application of fluids including various materials, elements, substances, compounds, and/or other items. Each evaluation zone 130 along each fluid sub-branch 120 has a different width in this example, as performance is improved by increasing shear force along the fluid sub-branch 120. As one example, each evaluation zone 130 may have a pressure between one-half dyne per square centimeter and two-and-one-half dynes per square centimeter.

Each fluid outlet 740 may be associated (and/or aligned) with a fluid port 520 of the top substrate 230, a fluid port 620 of the fluid interfacing adhesive 240, and a portion of channel cavity 420 that is aligned with the fluid ports 620 and 520 as shown. Fluid outlet 740 may be associated with various couplings and/or connectors that may allow resources such as waste receptacles to be coupled to the fluid outlets 740 and allow fluid to be expelled from the microfluidic test chip 100. In some embodiments, the fluid outlets 740 may be coupled to a controllable pump or similar component that may remove or collect fluid at a specified rate.

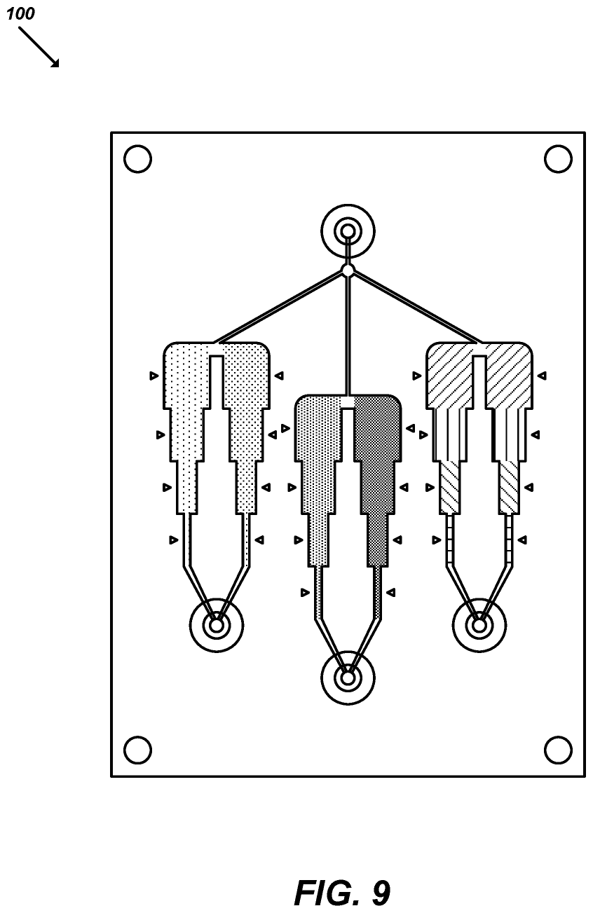

FIG. 8 illustrates a top-down view of a microfluidic test chip 100 of one or more embodiments described herein. This alternative arrangement includes the same channel cavity 420 as the microfluidic test chip 100 of FIG. 7, with a different arrangement of evaluation zones 130.

Different embodiments of the microfluidic test chip 100 may include various different channel cavities 420, with various different features, such as different numbers of fluid branches 110 (e.g., two, four, ten, twenty, etc.), different numbers of fluid sub-branches 120 associated with each fluid branch 110 (e.g., three, four, five, ten, twenty, etc.), and/or different numbers of evaluation zones 130 associated with each fluid sub-branch 120 (e.g., two, five, ten, twenty, etc.). As described above, the volumes of each fluid branch 110 may be matched such that even flow among the fluid branches 110 is achieved. Likewise, each associated fluid sub-branch 120 (e.g., fluid sub-branches 120 along the same branch 110) may have the same volume as each other associated fluid sub-branch 120 such that even flow among the fluid sub-branches 120 is achieved.

Returning to the example of FIG. 8, this example includes four sub-branches 120 that each include the same type of evaluation zone 130, as indicated by the fill patterns. Such a serial configuration may allow for testing a single reactant across a range of pressures or flow rates.

In addition, this example includes two matched sub-branches 120 with the same sequence of types of evaluation zone 130. Such a parallel configuration may allow for multiple test passes within a single evaluation. In this example, each of the matched sub-branches 120 includes a serial sequence of four different evaluation zones 130. Such a configuration may allow for evaluation of multiple elements across a range of pressures in a single test pass.

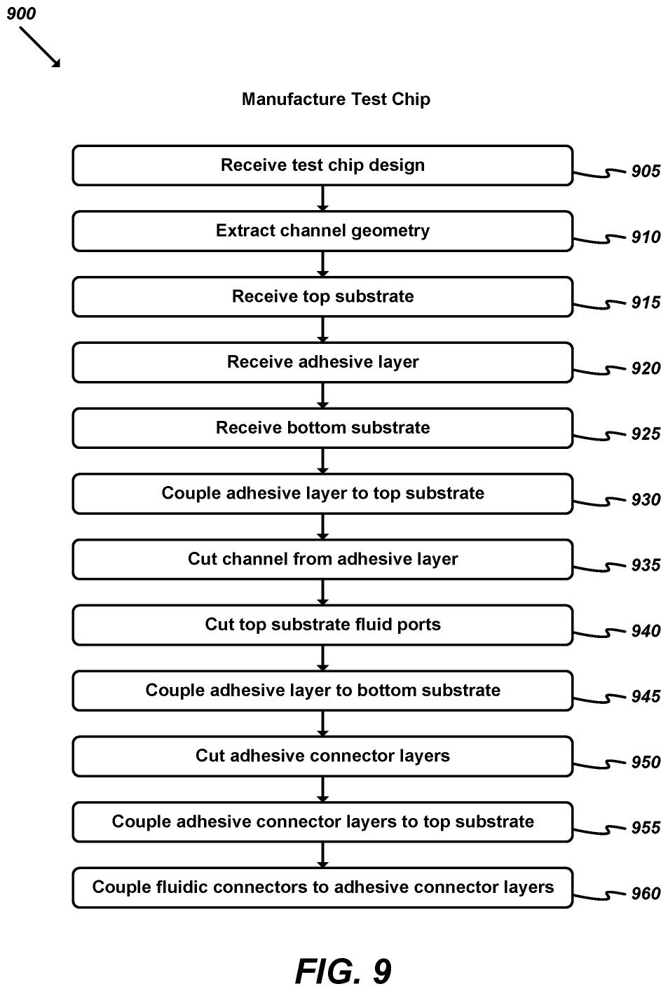

FIG. 9 illustrates an example process 900 for manufacturing a test chip of some embodiments, such as microfluidic test chip 100. The process may generate a multi-layer microfluidic test chip 100. The process may be performed whenever a microfluidic test chip 100 is manufactured. In some embodiments, process 900 may be performed by a device such as device 1200 described below that may include automated elements such as fixtures, clamps, tooling, robotic arms, etc.

As shown, process 900 may include receiving (at 905) a test chip design. The test chip design may be received from a storage or other appropriate resource. The test chip design may include various relevant informational elements that may define a microfluidic test chip 100. For example, the test chip design may include a listing of layers, such as layers 210-240. Each layer element may be associated with information such as material type(s), size of the layer, location of elements such as alignment features 310-710, channel cavity 420, fluid ports 620 or 520, and/or other appropriate information. Locations may be specified using coordinates (e.g., x, y coordinates), vector elements, and/or other appropriate ways. In some embodiments, a test chip design may be generated using a process such as process 1000 described below.

The process may include extracting (at 910) a channel geometry from the test chip design. The channel geometry may indicate the location of various elements associated with the channel, such as the shape and location of elements associated with the channel cavity 420.

Process 900 may include receiving (at 915) a top substrate, such as top substrate 230. The top substrate 230 may be received from a storage such as a clip or magazine and/or may otherwise be retrieved. The top substrate 230 may be coupled to, and aligned with, a fixture via one or more features such as alignment feature 510 and, for example, one or more posts of the fixture.

As shown, process 900 may include receiving (at 920) an adhesive layer, such as adhesive/channel layer 220. Adhesive/channel layer 220 may be received in a similar manner as the top substrate 230.

Process 900 may include receiving (at 925) a bottom substrate, such as bottom substrate 210. Bottom substrate 210 may be received in a similar manner to top substrate 230.

The bottom substrate 210 may include various substrate zones, such as evaluation zones 130. The attributes of the substrate zones (e.g., number, size, location, etc.) may be included in the test chip design information. In some cases, the bottom substrate 210 may already include such substrate zones (e.g., the bottom substrate 210 may be supplied with reactants already integrated with the bottom substrate 210). In some cases, the bottom substrate 210 may be “blank” and not include any previously defined zones. In such cases, sections of reactant material may be coupled to and/or integrated with the appropriate substrate zones (e.g., via diffusion, adhesion, etc.).

Each of the layers 210-230 may be stored at a fixture or similar resource and/or otherwise may be made available for additional processing.

Process 900 may include coupling (at 930) the adhesive layer, such as adhesive/channel layer 220, to the top substrate, such as top substrate 230. The adhesive/channel layer 220 may be coupled to the top substrate 230 via adhesive associated with a first surface of the adhesive/channel layer 220 (e.g., by removing a release liner from a first surface of adhesive/channel layer 220). The layers 220-230 may be coupled using a fixture or similar element to align the layers 220-230 and apply pressure.

As shown, process 900 may include cutting (at 935) the channel (e.g., channel cavity 420) from the adhesive layer (e.g., adhesive/channel layer 220) based on the extracted channel geometry. The adhesive/channel layer 220 may be cut using, for example, a carbon dioxide (CO₂) laser cutter. The test chip design may indicate the attributes of the channel cavity 420, such that the exterior (or “outline”, or “perimeter”) of the channel cavity 420 may be cut from the adhesive/channel layer 230. In some cases, the channel cavity 420 may be etched or otherwise removed from the adhesive/channel layer 220. After cutting the adhesive/channel layer 220, the inside section of the channel cavity 420 may be removed, the channel cavity 420 may be cleaned (e.g., using sonication, isopropyl alcohol, and/or other appropriate processing).

Process 900 may include cutting (at 940) top substrate fluid ports, such as fluid ports 520 from top substrate 230. The fluid ports 520 may be cut using, for example, a carbon dioxide (CO₂) laser cutter.

The process may include coupling (at 945) the adhesive layer, such as adhesive/channel layer 220 to the bottom substrate, such as bottom substrate 210. The bottom substrate 210 may be coupled to the adhesive/channel layer 220 (and the top substrate 230) by, for example, removing a release liner on a second surface of adhesive/channel layer 220). The layers 210-220 (and layer 230) may be coupled using a fixture or similar element to align the layers 210-230 and apply pressure.

The process may include cutting (at 950) adhesive connector layers, which may be similar to adhesive/channel layer 220. The adhesive connector layers may be received in a similar manner as top substrate 230. The adhesive connector layers may be cut to include ports or holes associated or aligned with, for example, fluid ports 520. The adhesive connector layers may be cut using, for example, a carbon dioxide (CO₂) laser cutter.

The process may include coupling (at 955) the adhesive connector layers to the top substrate, such as top substrate 230 (and adhesive/channel layer 220, and bottom substrate 210). The top substrate 230 may be coupled to the adhesive connector layers by, for example, removing a release liner on a first surface of the adhesive connector layers. The adhesive connector layers and top substrate 230 (and layers 210-220) may be coupled using a fixture or similar element to align the layers and apply pressure.

Process 900 may include coupling (at 960) fluidic connectors to adhesive connector layers, such as at the fluid inlet 720 and/or fluid outlets 740 of the microfluidic text chip 100.

One of ordinary skill in the art will recognize that various other processes may be used to manufacture the microfluidic test chip 100. For example, in some embodiments a lamination process may be used to generate a hermetically sealed microfluidic test chip 100. As another example, microfluidic test chip 100 (and/or portions thereof) may be manufactured using three-dimensional printing, injection molding, and/or other appropriate manufacturing operations.

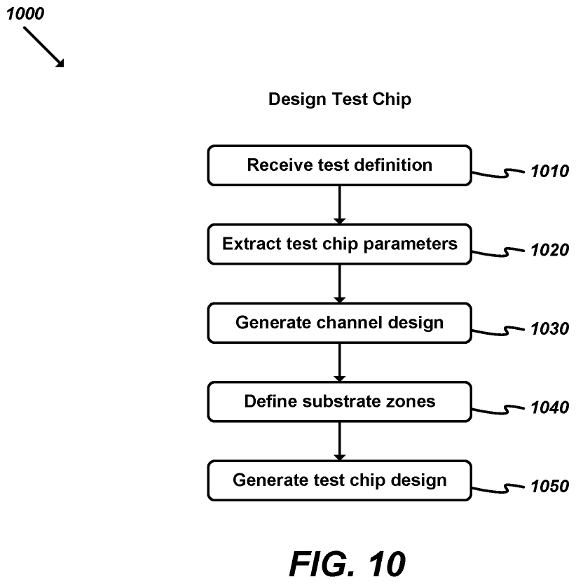

FIG. 10 illustrates an example process 1000 for designing a test chip of some embodiments, such as microfluidic test chip 100. The process may generate a channel design that distributes fluids to a set of evaluation zones 130 under appropriate conditions for the associated test(s). The process may be performed when a test chip is developed. In some embodiments, process 1000 may be performed by device 1200 described below.

As shown, process 1000 may include receiving (at 1010) a test definition. Such a test definition may include information such as, a listing of reactants or substances to evaluate, a listing of test parameters (e.g., flow rate, pressure, etc.) to evaluate, and/or other relevant information (e.g., whether multiple iterations should be placed in parallel, serial, etc.).

Process 1000 may include extracting (at 1020) test chip parameters. Such parameters may include information such as, for example, number of fluid branches 110, number of fluid sub-branches 120, number of evaluation zones 130, etc.

The process may include generating (at 1030) a channel design. A channel design may include, for example, a set of coordinates that define a shape such as channel cavity 420. The channel design may be generated in various appropriate ways. In some embodiments, a model of a default channel cavity 420 having an appropriate number of fluid branches 110, fluid sub-branches 120, and evaluation zones 130 may be received from a resource such as a storage. In some embodiments, a model of the channel cavity 420 may be built using a resource such as computer-assisted-design (CAD) software.

The model of the channel cavity 420 may be provided to a physics modeling tool that is able to model attributes such as pressure, flow, backpressure, inlet and/or outlet information, fluid phase, no-slip boundaries, etc. Based on the results of the physics modeling, the model of the channel cavity 420 may be adjusted (e.g., by changing widths of evaluation zones 130, by adding or removing sections of fluid conduit 730 and/or by adjusting the size of such sections, etc.). The model of the channel cavity 420 may be iteratively updated and evaluated in such a way until the results of the physics modeling meet some evaluation criteria (e.g., specified flow rates for each evaluation zone 130).

As shown, process 1000 may include defining (at 1040) substrate zones, such as substrate zones 130. The locations of evaluation zones 130 may be based at least partly on associated sections of the channel cavity 420 associated with the channel design generated (at 1030). Each evaluation zone 130 may be associated with one or more reactants.

The process may include generating (at 1050) a test chip design. The test chip design may include information elements that indicate relevant information such as layout of the channel cavity 420, location and other attributes of evaluation zones 130, location and/or other attributes of reference features 430, location and/or other attributes of alignment features 310-710, location and/or other attributes of fluid ports 620 or 520, and/or other relevant information. The test chip design may be saved to a file or similar resource that may be utilized during a manufacturing process, such as process 900.

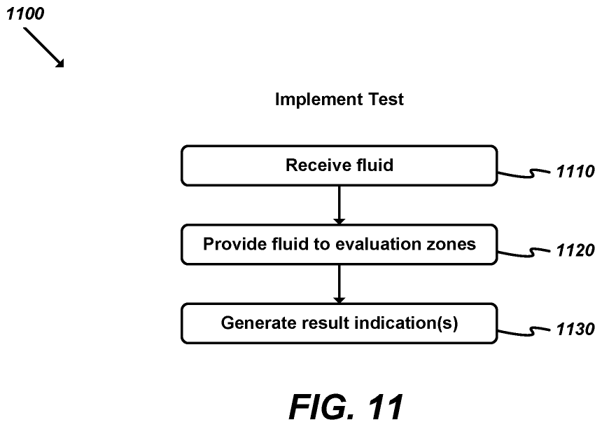

FIG. 11 illustrates an example process 1100 for implementing a test via the test chip of some embodiments, such as microfluidic test chip 100. The process may allow performance of various substances, components, etc. to be evaluated by exposure to different fluids and components thereof. The process may be performed whenever a test is implemented using the microfluidic test chip 100. In some embodiments, process 1100 may be performed by microfluidic test chip 100.

As shown, process 1100 may include receiving (at 1110) fluid. Fluid may be received via a feature such as fluid inlet 720. Fluid may be supplied by a resource such as a pump or syringe. The pressure or flow rate of the supplied fluid may be controllable and the microfluidic test chip 100 may be configured to operate with a specific flow rate or pressure, type of fluid, etc.

Process 1100 may include providing (at 1120) fluid to the evaluation zones, such as evaluation zones 130. Fluid may flow along conduit 730, fluid branches 110, fluid sub-branches 120 (including evaluation zones 130), and exit the microfluidic test chip 100 at fluid outlet 740. As described above, the various evaluation zones 130 (and/or other elements) may be sized such that desired flow rates or pressures are achieved at each evaluation zone 130 based on the attributes of the fluid supplied via fluid inlet 720.

The process may include generating (at 1130) result indications. In some embodiments, evaluation zones 130 may include reactive elements that may provide a visual indicator (e.g., by changing color, by revealing a graphic element or fill pattern, etc.) of adherence (and/or other attributes under evaluation) of some substance under evaluation. In some embodiments, evaluation zones 130 may be evaluated using microscopes and/or other appropriate equipment (e.g., fluorescent imaging and/or analysis equipment).

One of ordinary skill in the art will recognize that processes 900-1100 may be implemented in various different ways without departing from the scope of the disclosure. For instance, the elements may be implemented in a different order than shown. As another example, some embodiments may include additional elements or omit various listed elements. Elements or sets of elements may be performed iteratively and/or based on satisfaction of some performance criteria. Non-dependent elements may be performed in parallel. Elements or sets of elements may be performed continuously and/or at regular intervals.

The processes and modules described above may be at least partially implemented as software processes that may be specified as one or more sets of instructions recorded on a non-transitory storage medium. These instructions may be executed by one or more computational element(s) (e.g., microprocessors, microcontrollers, digital signal processors (DSPs), application-specific integrated circuits (ASICs), field programmable gate arrays (FPGAs), other processors, etc.) that may be included in various appropriate devices in order to perform actions specified by the instructions.

As used herein, the terms “computer-readable medium” and “non-transitory storage medium” are entirely restricted to tangible, physical objects that store information in a form that is readable by electronic devices.

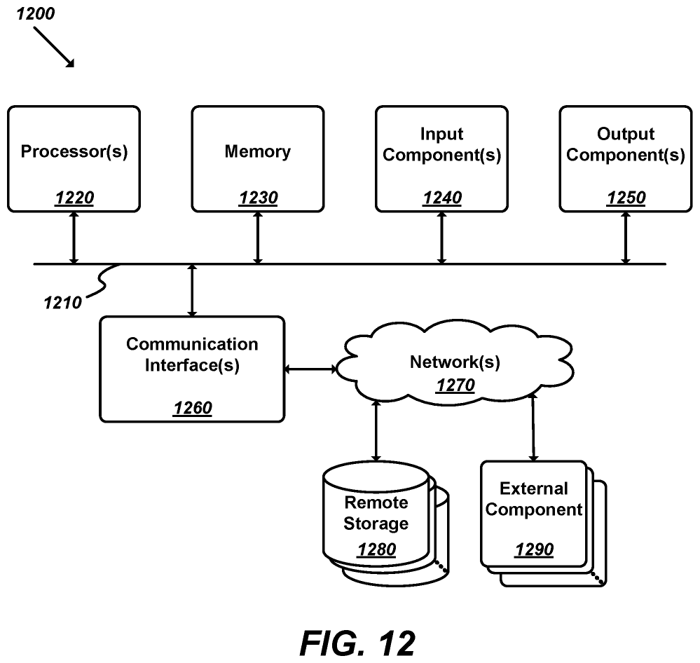

FIG. 12 illustrates a schematic block diagram of an exemplary device (or system or devices) 1200 used to implement some embodiments. For example, the processes described in reference to FIG. 9, FIG. 10, and FIG. 11 may be at least partially implemented using device 1200.

Device 1200 may be implemented using various appropriate elements and/or sub-devices. For instance, device 1200 may be implemented using one or more personal computers (PCs), servers, mobile devices (e.g., smartphones), tablet devices, wearable devices, and/or any other appropriate devices. The various devices may work alone (e.g., device 1200 may be implemented as a single smartphone) or in conjunction (e.g., some components of the device 1200 may be provided by a mobile device while other components are provided by a server).

As shown, device 1200 may include at least one communication bus 1210, one or more processors 1220, memory 1230, input components 1240, output components 1250, and one or more communication interfaces 1260.

Bus 1210 may include various communication pathways that allow communication among the components of device 1200. Processor 1220 may include a processor, microprocessor, microcontroller, DSP, logic circuitry, and/or other appropriate processing components that may be able to interpret and execute instructions and/or otherwise manipulate data. Memory 1230 may include dynamic and/or non-volatile memory structures and/or devices that may store data and/or instructions for use by other components of device 1200. Such a memory device 1230 may include space within a single physical memory device or spread across multiple physical memory devices.

Input components 1240 may include elements that allow a user to communicate information to the computer system and/or manipulate various operations of the system. The input components may include keyboards, cursor control devices, audio input devices and/or video input devices, touchscreens, motion sensors, etc. Output components 1250 may include displays, touchscreens, audio elements such as speakers, indicators such as light-emitting diodes (LEDs), printers, haptic or other sensory elements, etc. Some or all of the input and/or output components may be wirelessly or optically connected to the device 1200.

Device 1200 may include one or more communication interfaces 1260 that are able to connect to one or more networks 1270 or other communication pathways. For example, device 1200 may be coupled to a web server on the Internet such that a web browser executing on device 1200 may interact with the web server as a user interacts with an interface that operates in the web browser. Device 1200 may be able to access one or more remote storages 1280 and one or more external components 1290 through the communication interface 1260 and network 1270. The communication interface(s) 1260 may include one or more application programming interfaces (APIs) that may allow the device 1200 to access remote systems and/or storages and also may allow remote systems and/or storages to access device 1200 (or elements thereof).

It should be recognized by one of ordinary skill in the art that any or all of the components of computer system 1200 may be used in conjunction with some embodiments. Moreover, one of ordinary skill in the art will appreciate that many other system configurations may also be used in conjunction with some embodiments or components of some embodiments.

In addition, while the examples shown may illustrate many individual modules as separate elements, one of ordinary skill in the art would recognize that these modules may be combined into a single functional block or element. One of ordinary skill in the art would also recognize that a single module may be divided into multiple modules.

Device 1200 may perform various operations in response to processor 1220 executing software instructions stored in a computer-readable medium, such as memory 1230. Such operations may include manipulations of the output components 1250 (e.g., display of information, haptic feedback, audio outputs, etc.), communication interface 1260 (e.g., establishing a communication channel with another device or component, sending and/or receiving sets of messages, etc.), and/or other components of device 1200.

The software instructions may be read into memory 1230 from another computer-readable medium or from another device. The software instructions stored in memory 1230 may cause processor 1220 to perform processes described herein. Alternatively, hardwired circuitry and/or dedicated components (e.g., logic circuitry, ASICs, FPGAs, etc.) may be used in place of or in combination with software instructions to implement processes described herein. Thus, implementations described herein are not limited to any specific combination of hardware circuitry and software.

The actual software code or specialized control hardware used to implement an embodiment is not limiting of the embodiment. Thus, the operation and behavior of the embodiment has been described without reference to the specific software code, it being understood that software and control hardware may be implemented based on the description herein.

While certain connections or devices are shown, in practice additional, fewer, or different connections or devices may be used. Furthermore, while various devices and networks are shown separately, in practice the functionality of multiple devices may be provided by a single device or the functionality of one device may be provided by multiple devices. In addition, multiple instantiations of the illustrated networks may be included in a single network, or a particular network may include multiple networks. While some devices are shown as communicating with a network, some such devices may be incorporated, in whole or in part, as a part of the network.

Some implementations are described herein in conjunction with thresholds. To the extent that the term “greater than” (or similar terms) is used herein to describe a relationship of a value to a threshold, it is to be understood that the term “greater than or equal to” (or similar terms) could be similarly contemplated, even if not explicitly stated. Similarly, to the extent that the term “less than” (or similar terms) is used herein to describe a relationship of a value to a threshold, it is to be understood that the term “less than or equal to” (or similar terms) could be similarly contemplated, even if not explicitly stated. Further, the term “satisfying,” when used in relation to a threshold, may refer to “being greater than a threshold,” “being greater than or equal to a threshold,” “being less than a threshold,” “being less than or equal to a threshold,” or other similar terms, depending on the appropriate context.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

The foregoing relates to illustrative details of exemplary embodiments and modifications may be made without departing from the scope of the disclosure. Even though particular combinations of features are recited in the claims and/or disclosed in the specification, these combinations are not intended to limit the possible implementations of the disclosure. In fact, many of these features may be combined in ways not specifically recited in the claims and/or disclosed in the specification. For instance, although each dependent claim listed below may directly depend on only one other claim, the disclosure of the possible implementations includes each dependent claim in combination with every other claim in the claim set.

We claim:

1. A microfluidic test chip comprising:
an inlet that receives a fluid;
a plurality of fluid branches coupled to the inlet, each fluid branch from the plurality of fluid branches comprising a plurality of fluid sub-branches;
a set of evaluation zones distributed along of the fluid sub-branches from the plurality of fluid sub-branches;
a plurality of outlets that expel the fluid; and
a substrate comprising an evaluation area associated with each evaluation zone from the set of evaluation zones.

2. The microfluidic test chip of claim 1, wherein each fluid branch from the plurality of fluid branches has a same volume as each other fluid branch from the plurality of fluid branches.

3. The microfluidic test chip of claim 1, wherein the substrate is a nominally planar surface of defined composition, texture, and roughness.

4. The microfluidic test chip of claim 1, wherein the substrate is of a conformal material having substantial curvature or topography.

5. The microfluidic test chip of claim 1, wherein each fluid sub-branch from the plurality of fluid sub-branches has a same volume as each other fluid sub-branch from the plurality of fluid sub-branches.

6. The microfluidic test chip of claim 1, wherein a cross-section of each evaluation zone from the set of evaluation zones decreases along a fluid path from the inlet to the plurality of outlets, such that shear force increases along the fluid path from the inlet to the plurality of outlets.

7. The microfluidic test chip of claim 1, wherein each evaluation zone from the set of evaluation zones is integrated with a single substrate layer of the microfluidic test chip.

8. The microfluidic test chip of claim 1, wherein each evaluation zone from the set of evaluation zones comprises a biological particle, analyte, or species.

9. The microfluidic test chip of claim 8, wherein each evaluation zone from the set of evaluation zones provides an indication of adherence.

10. The microfluidic test chip of claim 9, wherein the indication of adherence may be evaluated via magnetic, spectroscopic, optical, fluorescent, impedance, electrical, photoluminescent, and/or radiological analysis.

11. A multi-layer microfluidic test chip comprising:
a bottom substrate;
a channel layer coupled to the bottom substrate via a first surface of the channel layer, wherein the channel layer comprises an inlet port, a channel cavity having a plurality of fluid branches, and a plurality of outlet ports; and
a top substrate coupled to the channel layer via a second surface of the channel layer.

12. The multi-layer microfluidic test chip of claim 11, wherein each fluid branch from the plurality of fluid branches comprises a plurality of fluid sub-branches, and wherein each fluid sub-branch from the plurality of fluid sub-branches comprises a set of evaluation zones.

13. The multi-layer microfluidic test chip of claim 12, wherein each fluid branch from the plurality of fluid branches has a same volume as each other fluid branch from the plurality of fluid branches.

14. The multi-layer microfluidic test chip of claim 12, wherein each fluid sub-branch from the plurality of fluid sub-branches has a same volume as each other fluid sub-branch from the plurality of fluid branches.

15. The multi-layer microfluidic test chip of claim 12, wherein the bottom substate comprises a plurality of reactants and each evaluation zone from the set of evaluation zones is associated with a region of the bottom substrate that comprises a particular reactant from the plurality of reactants.

16. The multi-layer microfluidic test chip of claim 12, wherein a volume of each evaluation zone from the set of evaluation zones decreases along a fluid path from the inlet port to the plurality of outlet ports, such that shear force increases along the fluid path from the inlet port to the plurality of outlet ports.

17. The multi-layer microfluidic test chip of claim 11, wherein the bottom substate, the channel layer, and the top substrate comprise at least one of a polymeric material comprising a condensation polymer, an addition polymer, and a natural polymer, the polymeric material having characteristics of a thermoplastic material or a thermoset material.

18. The multi-layer microfluidic test chip of claim 17, wherein the bottom substrate, the channel layer, and the top substrate comprise at least one of a polycarbonate, poly (acrylate), poly (methacrylate), an olefin including polypropylene (PP), polyethylene (PE), cyclic olefin & related copolymers, polyester including polyethylene terephthalate (PET), polyamides and aramids, polyimides, polystyrene (PS) and related substituted forms, polytetrafluoroethylene and related polyvinyl per-fluorinated or semi-fluorinated compositions, epoxies, silicones, polyurethanes, polyacrylonitrile (PAN), natural and synthetic rubbers, carbon-carbon materials, and elastomers.

19. The multi-layer microfluidic test chip of claim 17, wherein the bottom substate, the channel layer, and the top substrate comprise an inorganic material.

20. A method comprising:
receiving a test chip design;
extracting a channel geometry from the test chip design;
receiving a top substrate;
receiving an adhesive layer;
receiving a bottom substrate;
coupling the adhesive layer to the top substrate;
cutting a channel cavity from the adhesive layer;
cutting fluid ports in the top substrate; and
coupling the adhesive layer to the bottom substrate.

21. The method of claim 20, wherein cutting the channel cavity from the adhesive layer comprises:
applying a laser cutter along a perimeter of the channel cavity;
removing an interior portion of the channel cavity from the adhesive layer; and
cleaning the channel cavity.

22. The method of claim 20, wherein:
the channel cavity comprises a plurality of fluid branches,
each fluid channel from the plurality of fluid branches comprises a plurality of fluid sub-branches; and
each fluid sub-channel from the plurality of fluid sub-branches comprises a set of evaluation zones.

23. The method of claim 22, wherein each evaluation zone from the set of evaluation zones is associated with a section of the bottom substrate and each associated section of the bottom substrate comprises a reactant.

24. The method of claim 22, wherein the channel cavity comprises a fluid inlet and a plurality of fluid outlets.

25. The method of claim 24, wherein a volume of each evaluation zone decreases along a fluid path from the fluid inlet to the plurality of fluid outlets.
